(19) United States
(12) Patent Application Publication
(10) Pub. No.: US 2011/0229297 A1
(43) Pub. Date: Sep. 22, 2011

(54) TRAY DENESTER WITH AIR NOZZLE SEPARATORS

(75) Inventors: Michael J. Frazier, Watertown, WI (US); Tigran K. Sarajian, Oconomowoc, WI (US)

(73) Assignee: AXIS AUTOMATION, LLC, Hartland, WI (US)

(21) Appl. No.: 13/050,254

(22) Filed: Mar. 17, 2011

Related U.S. Application Data
(60) Provisional application No. 61/315,155, filed on Mar. 18, 2010.

(51) Int. Cl. B65G 59/10

(52) U.S. Cl. 414/795.6; 414/801

(57) ABSTRACT

A tray denester for separating individual trays from a stack. The tray denester includes a product carrier plate that is movable toward and away from the discharge end of a product magazine. The product carrier plate includes a pair of air nozzle assemblies. As the product carrier plate moves toward the discharge end of the magazine, the air nozzle assemblies are activated to create a low-pressure zone along the product carrier plate. When the product carrier plate reaches the discharge end, an escapement mechanism releases the stack of trays. As the stack of trays is released, the low-pressure zone separates one of the trays from the stack. The separated tray contacts the product carrier plate and is removed from the stack. Each of the air nozzle assemblies is adjustable along the product carrier plate to vary the position of the air nozzle assemblies based upon the specific tray design.

### CROSS-REFERENCE TO RELATED APPLICATION

The present application is based on and claims priority to U.S. Provisional Patent Application Ser. No. 61/315,155 filed on Mar. 18, 2010.

### BACKGROUND

The present disclosure generally relates to a tray denester. More specifically, the present disclosure relates to a tray denester having air nozzle separators to remove one tray from a stack of trays.

During normal packaging operations, products to be packaged are often placed in trays and further processed downstream from the packaging machine. Typically, product trays are shipped and stored in nested stacks in which each of the trays are placed in close contact with each other to reduce shipping costs. During the packaging operation, each tray must be separated from the stack of trays prior to loading the tray with a product. Many different types of mechanical assemblies have been developed to separate individual trays from a stack of trays for packaging. It is desirable that a tray denester be able to quickly and reliably separate trays from a stack to increase the packaging throughput of a facility. Further, it is desirable that the tray denester can be easily reconfigured to handle trays of different sizes.

### SUMMARY

The present disclosure relates to a tray denester capable of separating nested trays from a stack one at a time. The trays are placed in a magazine where gravity presents them to the escapement section of the machine. The escapement mechanism of each magazine holds the stack from coming in contact with the product carrier plate except when desired. The product carrier plate is driven in a reciprocal manner towards and away from the stack positioned in the magazine.

As the product carrier plate approaches the stack of trays, an air nozzle assembly is energized in a downward direction across the surface of the carrier plate. The focused air blast creates a low-pressure zone across the product carrier plate surface, which aids in drawing the first tray away from the stack. As the product carrier plate reaches the stack, the stack is released, causing the stack to come forward and contact the product carrier plate. At the moment the first tray contacts the product carrier plate, the energized air nozzle causes the first tray to be locked in place against the product carrier plate and the remaining stack to be repelled, thereby providing a path for the newly separated tray to be discharged.

After the separated tray is removed from the stack, the escapement mechanisms are activated and the product carrier plate moves away from the stack to discharge the tray onto a conveyor belt for downstream handling.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of the tray denester of the present disclosure;

FIG. 2 is a top, rear view of the tray denester showing the position of a pair of product carrier plates in both the loading and unloading positions;

FIG. 3 is a top view of the tray denester;

FIG. 4 is a magnified view similar to FIG. 2;

FIG. 5 is a magnified view of one of the carrier plates including the air nozzles and escapements;

FIG. 6 is a magnified view showing the mounting of each of the air nozzles used to separate the product trays; and

FIG. 7 is a schematic illustration of the control unit of the tray denester.

### DETAILED DESCRIPTION

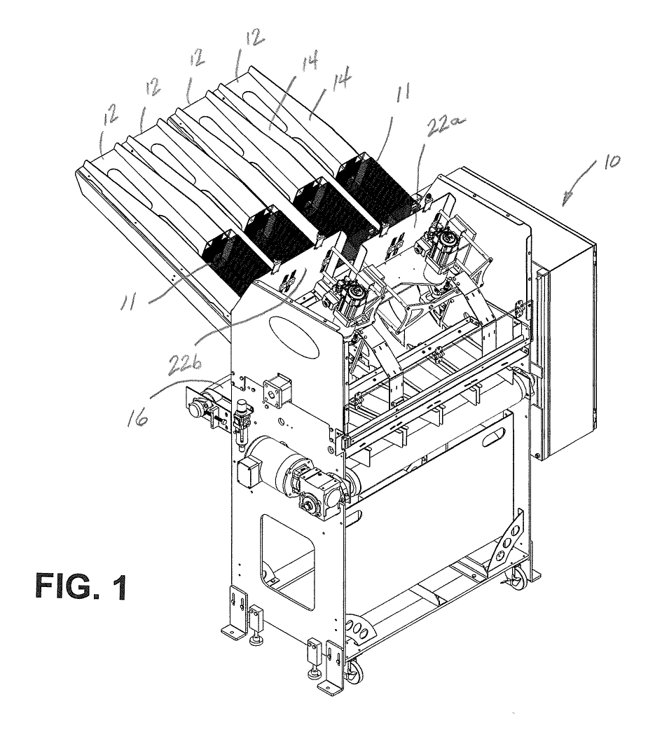

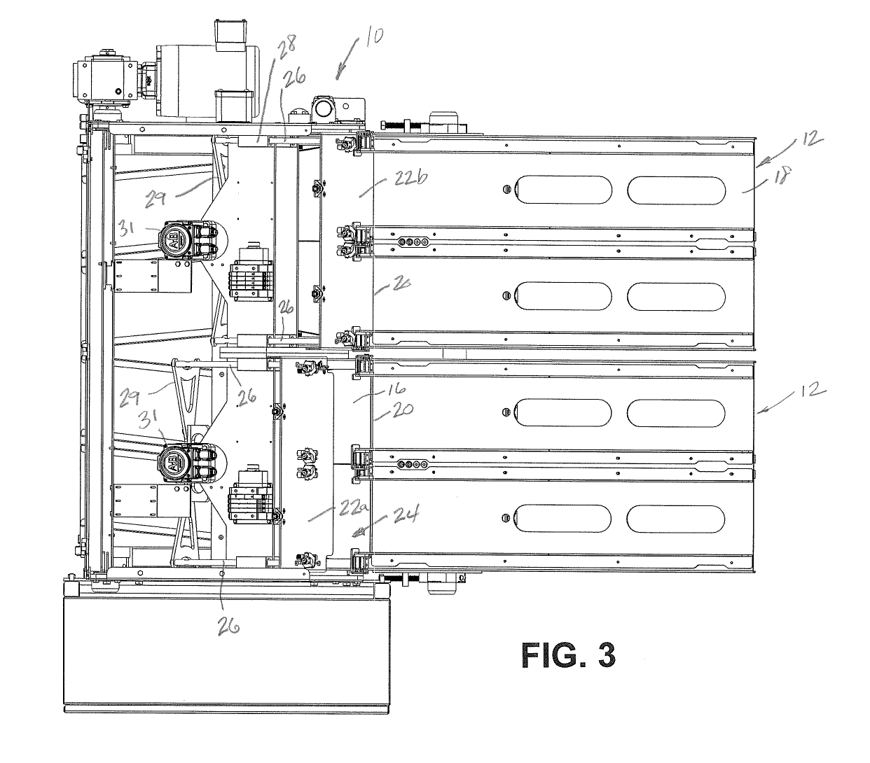

FIG. 1 illustrates a tray denester 10 that is used to dispense a series of trays from nested stacks 11 included in one of a series of product magazines 12. Each of the product magazines 12 includes a pair of sidewalls 14 that are spaced from each other by the width of the stack of trays 11 such that the magazine positions the trays in a desired orientation for separation. Once each individual tray has been separated from the stack 11, the individual tray is deposited on a chute or a conveyor 16 such that the individual trays can be fed to downstream equipment for further processing. The tray denester 10 is constructed to allow a variety of sizes of trays to be dispensed, as well as a large range of thicknesses for each individual tray. As illustrated in FIG. 3, each product magazine 12 includes a sloped floor 18 that directs the stack of trays through the force of gravity toward a discharge end 20.

As illustrated in FIG. 3, the tray denester 10 includes a pair of product carrier plates 22a and 22b that are each movable relative to one of the stationary product magazines 12. In the embodiment shown in FIG. 3, the product carrier plate 22a is shown in a retracted position while the product carrier plate 22b is shown in the extended position. When the carrier plate 22b is in the extended position, the face surface of the carrier plate 22b is positioned immediately adjacent the discharge end 20 of the sloped floor 18 of the magazine 12. When the product carrier plate 22a is in the retracted position shown in FIG. 3, a discharge opening 24 is created between the carrier plate 22 and the discharge end 20. As illustrated in FIG. 3, the discharge opening 24 allows trays to fall from the magazine 12 onto the conveyor belt 16. The conveyor belt 16 operates to remove the denested tray from the tray denester 10 and transport the tray for further processing at the packaging facility.

Referring back to FIG. 1, the pair of carrier plates 22a and 22b are each independently movable as illustrated. The first carrier plate 22a is aligned with the first two product magazines while the second carrier plate 22b is aligned with the second pair of product magazines.

Each of the carrier plates 22a, 22b are independently movable to separate a pair of trays from the stack. In the embodiment shown in FIG. 1, carrier plate 22a is in the retracted, discharge position while carrier plate 22b is in the extended, loading position.

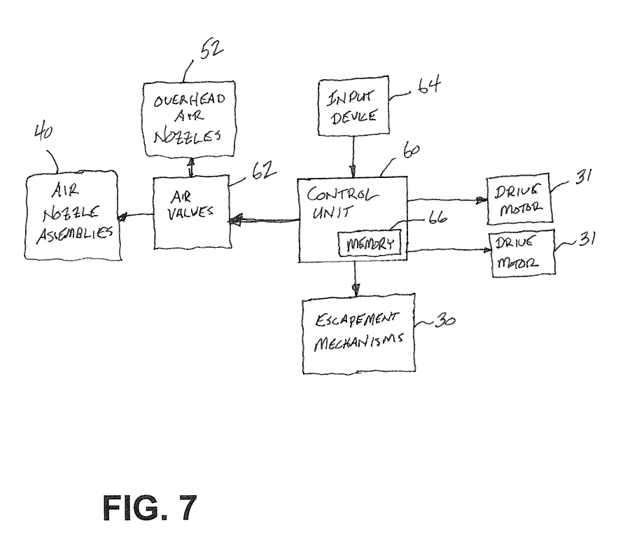

As can be seen in FIG. 3, each of the carrier plates 22a, 22b are mounted to a pair of rods 26 that can be selectively retracted and extended to move the carrier plates 22a, 22b between the discharge and loading positions. As shown in FIG. 3, each of the rods 26 pass through a stationary support block 28 that guides the movement of the rods. Each of the rods 26 is connected to a support bracket 29 that is movable as a result of the operation of a drive motor 31. Drive motors 31 are each operatively coupled to a control unit 60 (FIG. 7) for the tray denester 10 such that the control unit 60 can synchronize the operation of the drive motors 31 and thus the movement of the pair of carrier plates 22a, 22b. Although the use of a pair of spaced support rods 26 is shown in FIG. 3, it should be understood that various other mechanisms could be utilized for creating the reciprocal movement of the carrier plates 22a, 22b as shown and described.

The drive motors 31 can move the carrier plates 22a and 22b between an unlimited number of positions between the fully retracted and fully extended positions. The amount of movement of the carrier plates may depend upon the size of the tray being dispensed. As an example, the location of the retracted, discharge position can be different for different size trays. In this manner, the system can tailor the movement of the carrier plates 22a and 22b to the type of tray being dispensed.

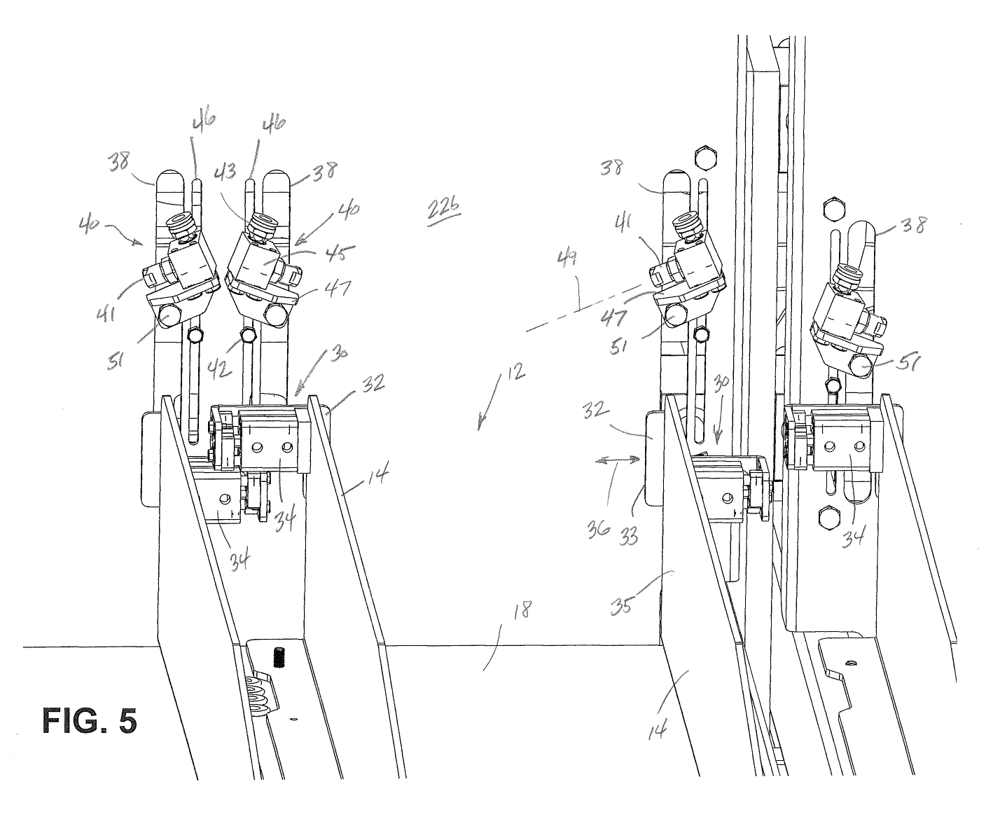

Referring back to FIG. 5, each of the product magazines 12 includes at least one escapement mechanism 30 that is operable to selectively control the position of the stack of trays. Each escapement mechanism 30 includes an escapement plate 32 that extends inward from the sidewalls 14 to restrict the movement of the stack of trays. When desired, a solenoid 34 of the escapement mechanism 30 can be activated to extend and retract to move the plate 32 in the direction shown by arrow 36.

As illustrated in FIG. 5, each of the product magazines 12 includes a pair of escapement mechanisms 30 mounted to each of the sidewalls 14 that define the width of the product magazine 12. Each escapement mechanism 30 includes its own escapement plate 32. When the escapement plate 32 is in the extended position shown in FIG. 5, the inside edge 33 of the escapement plate extends inwardly from the face surface 35 of the sidewall 14. Thus, the escapement plates 32 reduce the effective width of the product magazine 12. Preferably, the product magazine 12 has a width that is approximately equal to the width of the product trays being dispensed. Thus, when the escapement plates 32 are in the extended position shown in FIG. 5, the escapement plates 32 prevent the stack of trays from contacting the product carrier plate 22b.

As described above, each of the escapement plates 32 are movably mounted to a solenoid 34 such that the escapement plates 32 are movable from the extended position shown in FIG. 5 to a retracted position (not shown). When the escapement plates 32 are in the retracted position, the inside edge 33 is generally aligned with the face surface 35. When the escapement plates 32 are retracted, the stack of trays slide down the sloped floor 18 and into contact with the product carrier plate 22b.

Each of the solenoids 34 of the escapement mechanism 30 are operatively connected to the control unit 60 (FIG. 7) for the product denester such that the operation of the solenoids 34 can be coordinated with the movement of the product carrier plates 22, as will be described below.

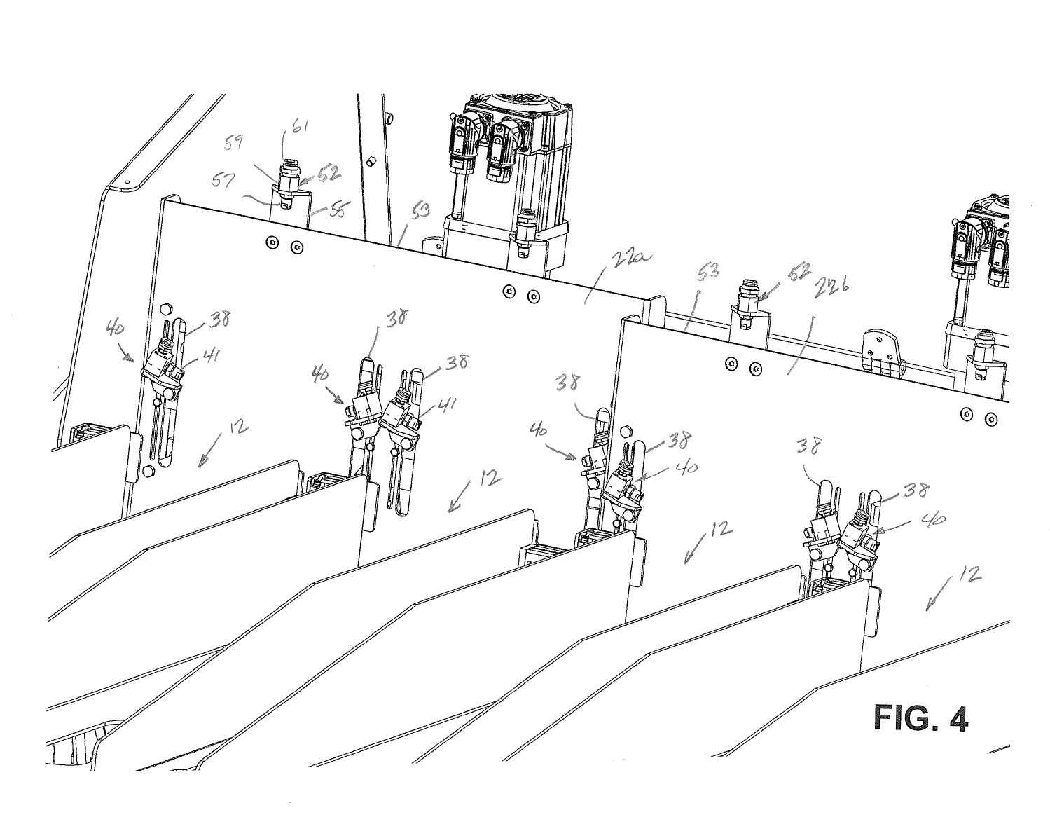

As illustrated in FIGS. 4 and 5, each of the carrier plates 22a and 22b includes a pair of nozzle openings 38 generally aligned with each of the product magazines 12. Each of the air nozzle openings 38 receives an air nozzle assembly 40. Each of the air nozzle assemblies 40 includes an air nozzle 41 and an air hose connection 43 each contained on a main body 45. The air hose connection 43 receives a supply of pressurized air that flows into the main body 45 and out of the nozzle 41. The nozzle 41 is specifically designed to direct air in a specific flow pattern. In the embodiment shown in FIG. 5, the main body 45 is mounted to a support bracket 47. The support bracket 47 is movable relative to the stationary product carrier plate 22b. The vertical position of the support bracket 47, and thus the air nozzle assembly 40, can be adjusted by loosening a connector 42. The connector 42 is movable within an adjustment slot 46 positioned directly adjacent to the nozzle openings 38. When the connector 42 is tightened, the vertical position of the support bracket 47 is secured. When it is desirable to adjust the vertical height of the air nozzle assembly 40, the connector 42 is loosened and the air nozzle assembly moved to the desired vertical position. Once in the desired vertical position, the connector 42 is again tightened to secure the air nozzle assembly in the adjusted position.

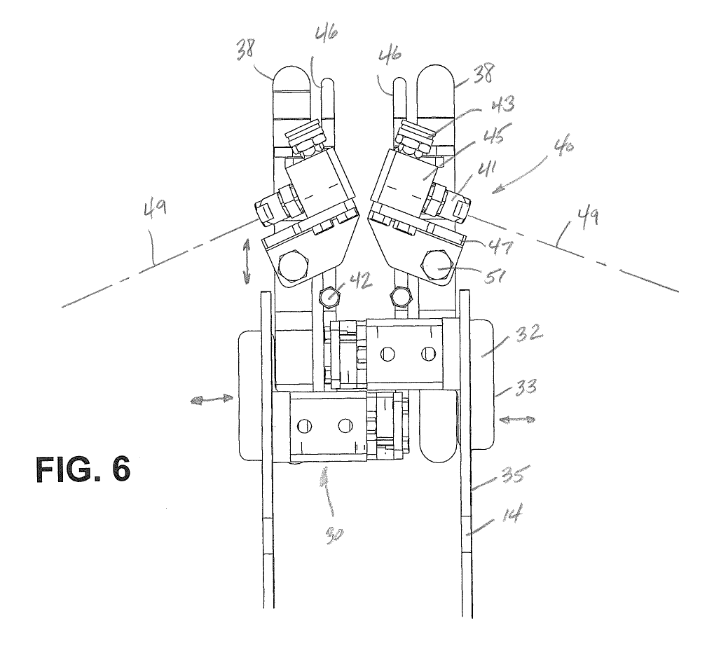

As can be seen in FIGS. 5 and 6, the air nozzle 41 is positioned such that the air nozzle creates a blast of air directed along an air flow axis 49. In the embodiment illustrated, the air flow axis 49 is selected to be approximately 45° relative to vertical. Although 45° is shown in the embodiments of FIGS. 5 and 6, it should be understood that the angle of the air flow axis 49 could be adjusted. The angle of the air flow axis can be adjusted by loosening connector 51 and adjusting the orientation of the support bracket 47 until the air flow axis 49 reaches the desired orientation.

As can be seen in FIG. 4, each of the air nozzle assemblies 40 are positioned to direct the flow of air both downward and toward the respective product carrier plate 22a, 22b. Thus, when the air nozzle assembly 40 receives the flow of pressurized air, air flow from the nozzle 41 flows toward the respective product carrier plate 22a, 22b to create an area of low pressure along the product carrier plate.

The operation of the tray denester will now be described.

As can be understood in FIG. 5, each of the escapement mechanisms 30 holds back the stack of trays in two different manners. The first is to actually position the escapement plate 32 in front of the stack of trays. The second is to provide sufficient side pressure to overcome the moments of force imposed on the trays by gravity. During operation, the control unit 60 sends a control signal to the escapement mechanisms 30 such that the mechanisms are opened at specific moments in order to release a stack of trays causing the stack of trays to drop and come into contact with the product carrier plate 22 when the product carrier plate 22 is in the loading position, as shown by product carrier plate 22b in FIG. 1.

At the moment right before the stack of trays comes into contact with the product carrier plate 22b, the control unit opens air valves 62 (FIG. 7), which allows a supply of air to flow to the air nozzle assembly 40. The control unit is programmed such that as the product carrier plate 22b moves toward the discharge end of the magazine 12, air is supplied to the air nozzle assembly. The supply of air is directed across the carrier plate 22b and forms a low-pressure zone due to the flow of air in this location. The low-pressure zone draws the first tray from the stack into contact with the carrier plate 22b. The continued stream of air from the air nozzle assembly 40 separates the first tray from the stack. In addition to separating the first tray, the flow of air repels the remaining stack away from the product carrier plate 22b.

As can be understood in FIG. 6, the focused air blast from the air nozzle assembly 40 is produced at a specific angle (45°) with respect to the product carrier plate through non-conical Venturies to produce an air blast with a modified fan pattern, longer in one axis than the other. This has the desired effect of holding the first tray in place while causing a volume of air to find its way through the minute opening between the first and second tray, causing the second tray and those above it to be lifted from the first.

The air nozzle assembly 40 shown in FIG. 6 helps to reduce air consumption by making better use of air proportioned to them. Furthermore, the focused air blast from the air nozzles has the added benefit of having a shorter rise time for the desired effect as more air reaches its intended target.

As illustrated in FIG. 6, the air nozzle assembly 40 is mounted directly to the support bracket 47 and is adjustable vertically by the series of the connectors 42.

The product carrier plates are each driven up and down in a reciprocal manner with a controlled servomotor or a stepper motor in a “cam profile”, which is a non-linear profile. The tray denester has a user definable engagement time of the tray to the product carrier plate to provide more flexibility to handle larger ranges of tray sizes.

The product carrier plate is guided with roller element bearings for positions to maintain a specific approach angle to hold the product in contact with the carrier plate once the tray has been engaged. The escapements and the air blasts are choreographed to the angular orientation of the crank arm that connects the drive system to the product carrier plate.

Once each tray is locked to the product carrier plate 22 by the focused air blast from the air nozzle assembly 40, the carrier plate 22 is retracted. As the product carrier plate 22 is retracted, there is a point where there is sufficient plate space to permit the tray to exit. As described above, this location will vary depending on the tray depth. The location is defined in the control unit for each type of tray dispensed. At the discharge location, the air blast from the air nozzle assemblies 40 are terminated and a focused blast from air nozzle assembly 52 (FIG. 4) positioned above the trays is created. As illustrated in FIG. 4, the air nozzle assembly 52 positioned above the top edge 53 of each of the product carrier plates 22a, 22b, includes a mounting bracket 55, an air nozzle 57, a body 59 and an air hose connector 61. As illustrated in FIG. 4, a separate air nozzle assembly 52 is provided for each of the product magazines 12. Thus, each of the air nozzle assemblies 52 can be activated to separate the product tray from the product carrier plate 22a or 22b to help direct the tray toward the conveyor assembly 16. The air blast from above is directing the tray onto the conveyor belt as described.

As can be understood by the above description and the schematic illustration of FIG. 7, the control unit 60 of the tray denester controls the timing of the operation of the various operational components within the tray denester. The timing of the operation of the various components of the tray denester allows the tray denester to selectively discharge one tray from the stack of trays for further processing downstream. The timing of the operation of the various components within the tray denester varies depending upon the type of tray being discharged. As an illustrative example, when the trays being discharged are thin and lightweight, the low-pressure zone created along the product carrier plate can be reduced by reducing the amount of air flow through the air nozzle assemblies. Alternatively, when the trays are heavy and thick, the air flow through the air nozzle assemblies must be increased to increase the low-pressure zone. Further, the operation of the escapement mechanism 30 must be properly coordinated depending upon the thickness and size of the trays.

Typically, the control unit 60 is programmed through an input device 64 which may be a touch screen, keyboard or other device that allows the operator to input commands and variables into the control unit 60. Once the desired operating parameters are determined for a particular type of tray, the operating parameters are stored within a memory unit 66 of the control unit 60 for later retrieval. Each time a new tray style is used with the tray denester, the control unit 60 stores the determined operating parameters and timing sequence in the memory unit 66. Thus, when the same or similar tray style is dispensed at a later date, the user can retrieve the operating parameters from the memory unit 66 through operation of the input device 64. In this manner, the operator can select different tray styles from a menu based upon past operation of the tray denester.

During operation of the tray denester, if the tray denester is not operating to discharge individual trays at an acceptable failure rate, the operator can adjust the operating parameters of the system through the input device 64. As an illustrative example, the use may increase the air flow provided to the air nozzle assemblies 40 by opening the air valve 62 earlier in the movement of the product carrier plate. Alternatively, the escapement mechanism may be delayed to prevent the stack of trays from reaching the product discharge plate until the product carrier plate gets closer to the discharge end of the magazine.

In one embodiment of the disclosure, the input device 64 includes a graphic user interface (GUI) that allows the user to select from various different menu selections in an intuitive manner. Various different types of GUIs are being contemplated as being within the scope of the present disclosure.

In the embodiment shown in FIG. 7, the control unit 60 is a microprocessor-based control unit. However, it is contemplated that different types of control units, such as a PLC or microcontroller could be utilized while operating within the scope of the present disclosure.

In the embodiment shown in FIG. 7, the control unit is operatively connected to various components of the tray denester. However, additional connections are contemplated as being within the scope of the present disclosure.

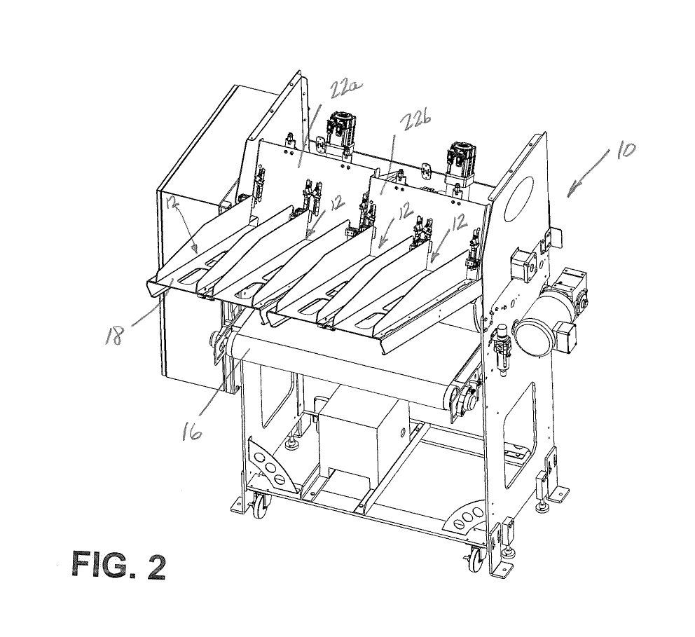

In the embodiments shown in FIGS. 1 and 2, the tray denester is shown having four product magazines 12, each of which are controlled by one of two product carrier plates 22a, 22b. The tray denester shown in FIGS. 1 and 2 is a modular device that can be modified easily by adding additional magazines to the denester. As an illustrative example, two additional magazines could be added to the tray denester 10 by simply adding a pair of magazines, an additional product carrier plate and the associate equipment needed to move the product carrier plate. In such an embodiment, the additional two magazines would be connected to the control unit and the control unit programmed to operate three separate product carrier plates and the associated equipment.

We claim:

1. A tray denester for separating individual trays from a stack of trays, comprising:
a plurality of magazines each for supporting a stack of trays;
an escapement mechanism positioned at a discharge end of each of the magazines for controlling the position of the stack of trays;
a product carrier plate movable relative to the discharge end of the magazine;
at least one air nozzle assembly mounted to the product carrier plate, wherein the air nozzle assembly is operable to separate a tray from the stack of trays and force the tray against the product carrier plate such that movement of the product carrier plate can selectively discharge the separated tray.

2. The tray denester of claim 1 wherein the air nozzle assembly is mounted to the product carrier plate at a downward angle relative to vertical.

3. The tray denester of claim 2 wherein the downward angle is approximately 45°.

4. The tray denester of claim 1 wherein two air nozzle assemblies are mounted to the product carrier plate for each of the plurality of magazines.

5. The tray denester of claim 4 wherein the air nozzle assemblies are positioned on opposite sides of each magazine.

6. The tray denester of claim 1 wherein two escapement mechanisms are positioned at the discharge end of each magazine.

7. The tray denester of claim 6 wherein each escapement mechanism includes an escapement plate movable between an extended position to restrict movement of the stack of trays and a retracted position to allow movement of the stack of trays.

8. The tray denester of claim 1 further comprising an overhead air nozzle assembly mounted to the product carrier plate and aligned with each of the magazines.

9. The tray denester of claim 8 wherein the overhead air nozzle assembly directs air along the product carrier plate.

10. A method of separating individual trays from a stack of tray, comprising the steps of:
positioning the stack of trays in a magazine having at least one escapement mechanism movable between a retracted position and an extended position;
moving a product carrier plate toward the magazine;
activating an air nozzle assembly mounted to the product carrier plate to create an air flow along the product carrier plate as the product carrier plate moves toward the magazine;
moving the escapement mechanism to the retracted position to release the stack of trays, wherein the air flow separates one tray from the stack of trays;
moving the product carrier plate away from the magazine to separate the one tray from the stack of trays; and
deactivating the air nozzle assembly to release the one tray from the product carrier plate.

11. The method of claim 10 further comprising the step of mounting the air nozzle assembly to the product carrier plate at a downward angle relative to vertical.

12. The method of claim 11 wherein the downward angle is approximately 45°.

13. The method of claim 10 further comprising the step of activating an overhead air nozzle assembly after moving the product carrier plate away from the magazine to separate the one tray from the product carrier plate.

14. The method of claim 10 wherein the air nozzle assembly is activated before the product carrier plate reaches the magazine to create a low-pressure zone along the product carrier plate.

15. A tray denester for separating individual trays from a stack of trays, comprising:
a plurality of magazines each for supporting a stack of trays;
an escapement mechanism positioned at a discharge end of each of the magazines, the escapement mechanism movable between an extended position to restrict the movement of the stack of trays and a retracted position to allow the movement of the stack of trays relative to the magazine;
a product carrier plate movable relative to the discharge end of the magazine; and
a pair of air nozzle assemblies mounted to the product carrier plate for each of the magazines, wherein the air nozzle assemblies are operable to create a flow of air along the product carrier plate to separate a tray from the stack of trays and force the tray against the product carrier plate.

16. The tray denester of claim 15 wherein the air nozzle assembly is mounted to the product carrier plate at a downward angle relative to vertical.

17. The tray denester of claim 16 wherein the downward angle is approximately 45°.

18. The tray denester of claim 15 wherein the product carrier plate is movable to an adjustable discharge position spaced from the discharge end of the magazine.

19. The tray denester of claim 15 wherein each of the air nozzle assemblies are movable along the product carrier plate.

20. The tray denester of claim 15 wherein the angle of the air nozzle assembly is adjustable relative to the product carrier plate.
